(19) United States
(12) Patent Application Publication
(10) Pub. No.: US 2016/0177739 A1
(43) Pub. Date: Jun. 23, 2016

(54) TURBINE BLADE HAVING HEAT SINKS THAT HAVE THE SHAPE OF AN AEROFOIL PROFILE

(71) Applicant: SIEMENS AKTIENGESELLSCHAFT, München (DE)

(72) Inventor: Fathi Ahmad, Kaarst (DE)

(73) Assignee: Siemens Aktiengesellschaft, Munich (DE)

(21) Appl. No.: 14/906,322

(22) PCT Filed: Jul. 4, 2014
(86) PCT No.: PCT/EP2014/064288

§ 371 Date: Jan. 20, 2016

(30) Foreign Application Priority Data
Jul. 29, 2013 (EP) 13178387.0

(51) Int. Cl. F01D 5/18

(52) U.S. Cl. CPC F01D 5/187; F05D 2260/2212

(57) ABSTRACT

A turbine blade has a pressure side, a suction side, and a cooling air channel, which is arranged between the pressure side and the suction side and which is bounded by inner surfaces of the pressure side and of the suction side. A cylindrical heat sink having a base surface, which has the shape of an aerofoil profile and has a profile top side and a profile bottom side, is arranged in the cooling air channel, which heat sink extends from the pressure side to the suction side. Turbulators are arranged on the inner surface of the pressure side and/or of the suction side in a region adjacent to the heat sink. The turbulators are arranged in such a way that lower air turbulence is produced in a region adjacent to the profile top side than in a region adjacent to the profile bottom side.

### CROSS REFERENCE TO RELATED APPLICATIONS

This application is the US National Stage of International Application No. PCT/EP2014/064288 filed Jul. 4, 2014, and claims the benefit thereof. The International Application claims the benefit of European Application No. EP13178387 filed Jul. 29, 2013. All of the applications are incorporated by reference herein in their entirety.

### FIELD OF INVENTION

The invention relates to a turbine blade having a pressure side, a suction side and, arranged therebetween, a cooling air duct bounded by inner surfaces of the pressure side and of the suction side, wherein in the cooling air duct there is arranged a cylindrical heat sink having a base surface in the shape of an airfoil profile, with a profile upper side and a profile underside, which extends from the pressure side to the suction side, wherein the base surface is in the inner surface of the pressure side or of the suction side, wherein turbulators are arranged on the inner surface of the pressure side and/or of the suction side, in the region of the heat sink.

### BACKGROUND OF INVENTION

A turbine is a turbomachine which converts the internal energy (enthalpy) of a flowing fluid (liquid or gas) into rotational energy and finally into mechanical drive energy. As the fluid flow flows as turbulence-free and laminar as possible around the turbine blades, part of the internal energy of the fluid flow is extracted therefrom and is taken up by the rotor blades of the turbine. These then turn the turbine shaft and the useful power is provided to a machine coupled thereto, such as for example a generator. The rotor blades and the shaft are parts of the moving rotor or spool of the turbine, which is arranged within a casing.

In general, multiple blades are mounted on the axis. Rotor blades mounted in a plane form respectively a blade ring or rotor ring. The blades have a slightly curved profile, similar to an aircraft airfoil. A stator ring is generally located upstream of each rotor ring. These stator blades project from the casing into the flowing medium and cause it to swirl. The swirl (kinetic energy) generated in the stator ring is used in the subsequent rotor ring to turn the shaft on which the rotor ring blades are mounted. The stator ring and rotor ring together are termed a stage. Frequently, multiple such stages are connected in series.

The turbine blades of a turbine are subjected to particular loads. The high loads require extremely resistant materials. Turbine blades are therefore made of titanium alloys, nickel superalloys or tungsten-molybdenum alloys. The blades are protected by coatings for greater resistance with respect to temperatures and erosion such as for example pitting corrosion. The coating for heat protection is termed thermal barrier coating or TBC for short. Other measures to provide the blades with greater heat resistance consist of elaborate cooling duct systems. This technique is used both in stator blades and in rotor blades.

In many cases, cooling ducts—extending between the pressure and suction sides of the turbine blade profile—are cast into the turbine blades. In that context, the cooling ducts are bounded by the inner surfaces of the pressure and suction sides and by other introduced boundary walls. In order to improve the cooling effect of the throughflowing air, heat sinks known as “pin fins” are arranged as required; these can have various shapes and can in particular also be shaped in cross section in the manner of an airfoil profile. Such heat sinks are known to a person skilled in the art for example from EP 0 230 917, EP 0 034 961 and U.S. Pat. No. 5,536,143.

These heat sinks are introduced into the turbine blade during the casting process. Furthermore, on the inner surface of the cooling duct, in particular on the inner surface of the outer walls of the turbine blade in the region of these pin fins, there are frequently attached turbulators which provide additional air turbulence and improve the cooling effect.

Currently, the thermal load on the turbine blades limits the efficiency of the turbine since the materials permit only a limited operating temperature. However, high operating temperatures have a positive effect on the Carnot efficiency.

### SUMMARY OF INVENTION

The invention therefore has an object of indicating a turbine blade of the type mentioned in the introduction, which permits an improved cooling air effect and thus higher operating temperatures and higher efficiency of the turbine.

This object is achieved according to the invention in that the turbulators are arranged such that less air turbulence is generated in a region adjoining the profile upper side than in a region adjoining the profile underside.

In that context, the invention proceeds from the consideration that hitherto, when using heat sinks, in particular those with an airfoil profile, the thermal gradient caused by the heat sinks is not taken into account. Such a thermal gradient can signify an increase in the thermal load on the component, which reduces service life. In this context, it has been recognized that heat sinks with an airfoil profile produce such a thermal gradient since the cooling air flows faster over the upper side, i.e. that side on which, due to the curvature of the profile, the air must take a longer path from the profile leading edge to the profile trailing edge. As a consequence, the heat transfer is namely improved on the upper side in comparison to the underside. For that reason, in order to avoid the thermal gradient, the transfer of heat on the underside should be increased. This can be brought about by increased turbulent flow, i.e. air turbulence in the region of the underside. To that end, the turbulators on the inner surface of the cooling duct should be arranged such that less air turbulence is generated in the region adjoining the profile upper side than in the region adjoining the profile underside.

Advantageously, to that end, a greater number of turbulators are arranged in the region adjoining the profile underside of the heat sink than in the region adjoining the profile upper side. As turbulators, use can be made of any type of artificially attached surface disruptions which change a laminar flow into a turbulent flow, such as e.g. transverse rails, small vertical plates or holes. If more turbulators are arranged on the profile upper side, the desired effect of greater air turbulence is achieved here.

More advantageously, in that context, no turbulators are arranged in the region adjoining the profile upper side of the heat sink. This minimizes air turbulence in the region of the profile upper side, such that the transfer of heat is reduced. This also contributes to balancing the transfer of heat on the profile upper side and underside.

In one advantageous embodiment, the turbulators have edges oriented at an angle of more than 45 degrees with respect to a main flow direction in the cooling air duct. The respective turbulator is in that context embodied as a rail introduced transversely with respect to the air flow. Such a shape is relatively simple to introduce in the casting process and reliably generates air turbulence.

In an alternative or additional advantageous embodiment, the air turbulence can also be increased in that turbulators arranged in the region adjoining the profile underside of the heat sink are more convex than turbulators arranged in the region adjoining the profile upper side. In other words: the turbulators arranged on the profile underside extend further into the interior of the cooling air duct and thus generate more pronounced turbulence.

Advantageously, the turbulators are arranged such that the heat discharge from the profile upper side corresponds to that of the profile underside. This optimally achieves the object of eliminating the thermal gradient. The configuration of the turbulators can in that context be determined by computational modeling or by series of tests.

Advantageously, a plurality of heat sinks is arranged in the cooling air duct, in particular in a grid pattern. It is for example possible to form a regular grid of such heat sinks, through which the cooling air flows. The grid arrangement provides minimum obstruction to through flow of the cooling air while at the same time a multiplicity of heat sinks can give off heat to the cooling air.

Furthermore, the cooling air duct advantageously adjoins a profile trailing edge of the turbine blade. Namely, the separation between the pressure side and suction side of the turbine blade is smallest at the trailing edge of the airfoil-like profile of the turbine blade since these converge there at an acute angle. For that reason, less cooling air can flow here in comparison to more central regions of the turbine blade, such that it is advantageous specifically here to increase the surface area available for exchange of heat using heat sinks with turbulators, configured as described.

A stator or rotor for a turbine advantageously comprises such a turbine blade as a stator blade or rotor blade.

A turbine advantageously comprises such a stator and/or rotor.

Advantageously, the turbine is in that context configured as a gas turbine. Particularly in gas turbines, the thermal and mechanical loads are particularly high, such that the described embodiment of the turbine blade offers particular advantages with respect to cooling and thus also efficiency.

A power plant advantageously comprises such a turbine.

The advantages achieved with the invention consist in particular in that avoiding a thermal gradient using heat sinks having an airfoil profile in the cooling duct of a turbine blade achieves an improvement in cooling, in particular at the profile trailing edge of a turbine blade. The service life of the turbine blade is increased, such that higher temperatures on the outside of the turbine blade are possible. This raises the efficiency of the turbine.

### BRIEF DESCRIPTION OF THE DRAWINGS

Exemplary embodiments of the invention will be explained in more detail with reference to a drawing, in which:

FIG. 1 shows a partial longitudinal section through a gas turbine,

FIG. 2 shows the profile of a rotor blade,

FIG. 3 shows a longitudinal section through the rotor blade,

FIG. 4 shows pin fins with turbulators in the region of the profile underside, and

FIG. 5 shows a different number of pin fins with turbulators on the profile underside and upper side.

### DETAILED DESCRIPTION OF INVENTION

In all figures, the same parts have been provided with the same reference signs.

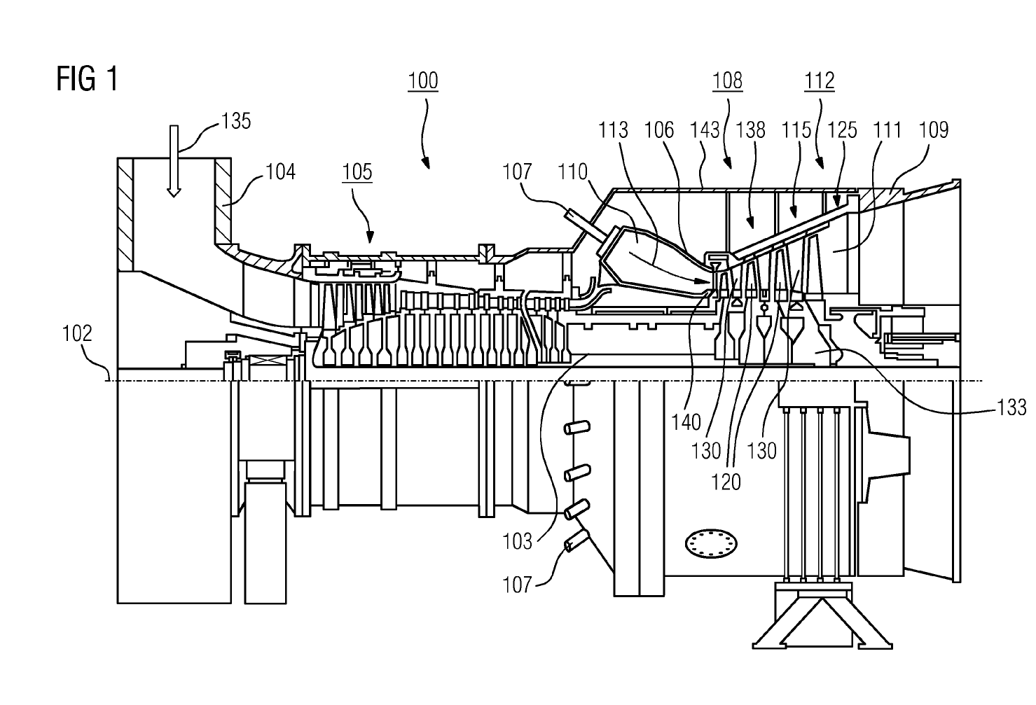

FIG. 1 shows a turbine 100, in this case a gas turbine, in partial longitudinal section. In the interior, the gas turbine 100 has a rotor 103 which is mounted such that it can rotate about an axis of rotation 102 (axial direction) and is also referred to as the turbine rotor. An intake housing 104, a compressor 105, a toroidal combustion chamber 110, in particular an annular combustion chamber 106, with a plurality of coaxially arranged burners 107, a turbine 108 and the exhaust-gas housing 109 follow one another along the rotor 103.

The annular combustion chamber 106 is in communication with an annular hot gas duct 111. There, for example, four series-connected turbine stages 112 form the turbine 108. Each turbine stage 112 is formed from two blade rings. As seen in the direction of flow of a working medium 113, in the hot gas duct 111 a row of stator blades 115 is followed by a row 125 formed from rotor blades 120.

In that context, the stator blades 130 are secured to the stator 143, whereas the rotor blades 120 of a row 125 are fitted to the rotor 103 by means of a turbine disk 133. The rotor blades 120 are thus a constituent part of the rotor or spool 103. A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot gas duct 111 past the stator blades 130 and the rotor blades 120. The working medium 113 expands at the rotor blades 120, imparting its momentum, so that the rotor blades 120 drive the rotor 103 and the latter drives the generator coupled to it.

While the gas turbine 100 is operating, the components which are exposed to the hot working medium 113 are subject to thermal stresses. The stator blades 130 and rotor blades 120 of the first turbine stage 112, as seen in the direction of flow of the working medium 113, together with the heat shield tiles which line the annular combustion chamber 106, are subject to the highest thermal stresses. To be able to withstand the temperatures which prevail there, they are cooled by means of a coolant. Equally, the blades 120, 130 can have anti-corrosion coatings (MCrAlX; M=Fe, Co, Ni, rare earths) and thermal barrier coatings (for example ZrO2, Y2O4—ZrO2).

Each stator blade 130 has a stator blade root (not shown here) which faces the inner casing 138 of the turbine 108, and a stator blade tip, which is at the opposite end from the stator blade root. The stator blade tip faces the rotor 103 and is fixed to a sealing ring 140 of the stator 143. In that context, each sealing ring 140 surrounds the shaft of the rotor 103.

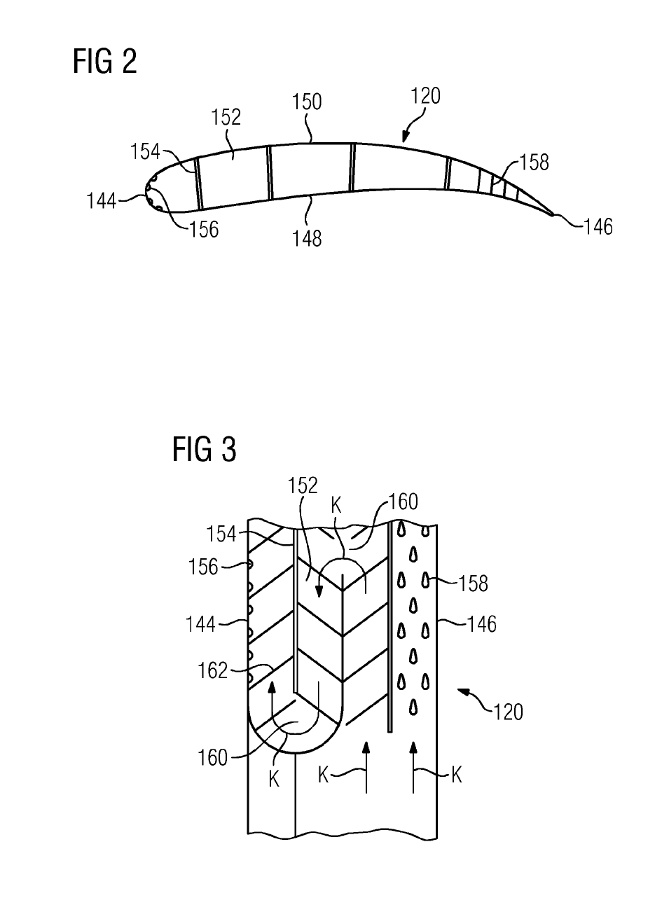

FIG. 2 shows, by way of example, the profile of a stator blade 120. The profile is similar to that of an aircraft airfoil. It has a rounded leading edge 144 and a trailing edge 146. The pressure side 148 and the suction side 150 of the rotor blade extend between the leading edge 144 and the trailing edge 146. Cooling air ducts 152, which extend along the main direction of extent of the rotor blade 120, perpendicular to the plane of FIG. 2, are introduced between the pressure side 148 and the suction side 150 and are separated from one another by walls 154.

In that context, there are provided, in the region of the leading edge 144, cooling air outlet openings 156 through which the cooling air can exit and thus forms a protective cooling film on the outside of the rotor blade 120. In the cooling air duct 152 adjoining the trailing edge 146, there are additionally arranged heat sinks 158, what are termed “pin fins”. These are cylindrical, i.e. formed as a body bounded by two parallel, planar, congruent surfaces (base and top face) and by a lateral or cylinder surface, wherein the lateral surface is formed by parallel straight lines. In that context, the base and top faces are in the boundary wall of the cooling air duct 152, i.e. the inner surface of the pressure side 148 and, respectively, of the suction side 150. The heat sinks 158 improve, by virtue of their surface in the cross section of the cooling air, the transfer of heat between the cooling air and the rotor blade 120. In that context, the heat sinks 158 have an airfoil profile, i.e. the base and top faces are in the form of an airfoil profile. This airfoil profile shape thus results in a lateral section of the heat sink that corresponds to the profile upper side of the airfoil profile, and a further lateral section that corresponds to the profile underside of the airfoil profile.

FIG. 3 shows the rotor blade 120 in longitudinal section. This shows that the three parallel cooling ducts 152 adjoining the leading edge 144 are connected via openings 160 such that they form a meander-shaped common duct. Cooling air K enters at the lower end of FIG. 3 and is redirected in the opposite direction at each opening 160 and so flows further along the duct until it finally leaves at the cooling air outlet openings 156.

In these four cooling air ducts 152, turbulators 162 are arranged on the flat outer side of the rotor blade 120 transversely with respect to the respective main flow direction of the cooling air K. Turbulators 162 are small, artificially attached surface disruptions. They generate turbulence and change a laminar boundary layer flow into a turbulent boundary layer flow. Turbulators 162 consist for example of transverse rails, small vertical plates or holes. In the exemplary embodiment, they take the form of cooling ribs which, as turbulators 162, improve the transfer of heat and thus the cooling effect. The cooling air duct 152 oriented toward the trailing edge 146 is, by contrast, connected separately and has, as described, heat sinks 158. FIG. 3 shows that the heat sinks 158 form a regular grid.

The described cooling structure was explained using the example of a rotor blade 120. Such cooling structures can also accordingly be provided in stator blades 130. The configuration of the heat sinks 158 and of the turbulators 162, as described below, can also be implemented there.

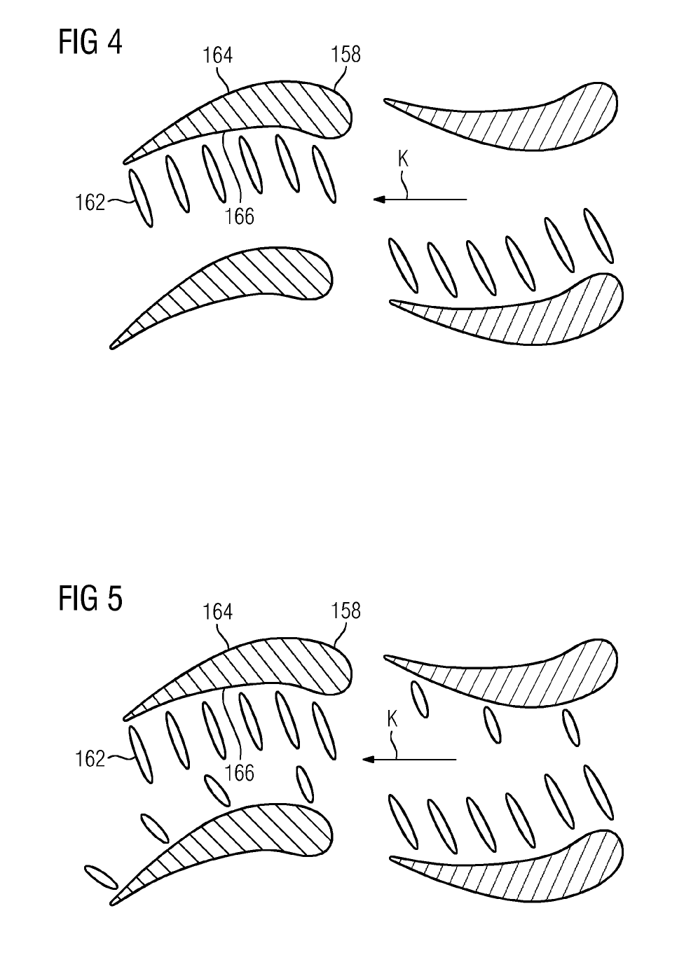

FIG. 4 shows, in enlarged detail, the cooling duct 152 oriented toward the trailing edge 146 of the turbine blade 120, 130. It shows four heat sinks 158 in the cooling duct 152 with the main flow direction of the cooling air K. The heat sinks have an airfoil profile whose curvature defines a profile upper side 164 in the direction of the curvature and a profile underside 166 on the reverse of the curvature. The direction of the curvature changes in the course of the main flow direction. The turbulators 162 are in the form of cooling ribs, i.e. raised portions oriented transversely (at an angle of greater than 45 degrees) with respect to the main flow direction.

In FIG. 4, turbulators 162 are arranged only in the region of the respective profile underside 166. No turbulators 162 are arranged in the region of the respective profile upper side 164 of the heat sinks 158.

In the alternative embodiment of FIG. 5, in contrast to FIG. 4, turbulators 162 are also arranged in the region of the respective profile upper side 164, but in reduced number and extent, in the cooling duct 152.

The configuration of the turbulators 162 is thus such that air turbulence on the profile upper side 164 is less than on the profile underside 166, such that the transfer of heat into the cooling air K is improved on the profile underside 166. In that context, the turbulators 162 are configured such that the transfer of heat on the profile underside 166 and on the profile upper side 164, into the cooling air K, is equal, i.e. the increased transfer of heat by virtue of the increased cooling air speed on the profile upper side 164 is compensated for. This avoids a thermal gradient across the heat sink 158.

1. A turbine blade comprising:
a pressure side, a suction side and, arranged therebetween, a cooling air duct bounded by inner surfaces of the pressure side and of the suction side,
wherein in the cooling air duct there is arranged a cylindrical heat sink having a base surface in the shape of an airfoil profile, with a profile upper side and a profile underside, which extends from the pressure side to the suction side,
wherein the base surface is in the inner surface of the pressure side or of the suction side, wherein turbulators are arranged on the inner surface of the pressure side and/or of the suction side, in a region adjoining the heat sink, and
wherein the turbulators are arranged such that less air turbulence is generated in a region adjoining the profile upper side than in a region adjoining the profile underside.

2. The turbine blade as claimed in claim 1,
wherein a greater number of turbulators are arranged in the region adjoining the profile underside of the heat sink than in the region adjoining the profile upper side.

3. The turbine blade as claimed in claim 2,
wherein no turbulators are arranged in the region adjoining the profile upper side of the heat sink.

4. The turbine blade as claimed in claim 1,
wherein the turbulators have edges oriented at an angle of more than 45 degrees with respect to a main flow direction in the cooling air duct.

5. The turbine blade as claimed in claim 1,
wherein turbulators arranged in the region adjoining the profile underside of the heat sink are formed more convex than turbulators arranged in the region adjoining the profile upper side.

6. The turbine blade as claimed in claim 1,
wherein the turbulators are arranged such that the heat discharge from the profile upper side corresponds to that of the profile underside.

7. The turbine blade as claimed in claim 1, further comprising:
in which a plurality of heat sinks is arranged in the cooling air duct.

8. The turbine blade as claimed in claim 1,
wherein the cooling air duct adjoins a profile trailing edge of the turbine blade.

9. A stator or rotor for a turbine comprising:
a turbine blade as claimed in claim 1.

10. A turbine comprising:
a stator and/or rotor as claimed in claim 9.

11. The turbine as claimed in claim 10,
which is configured as a gas turbine.

12. A power plant comprising:
a turbine as claimed in claim 10.
